(19) United States
(12) Patent Application Publication
(10) Pub. No.: US 2024/0110053 A1
(43) Pub. Date: Apr. 4, 2024

(54) LOW-MOLECULAR-WEIGHT ORGANIC RESIN AND AQUEOUS DISPERSION COMPRISING SAME, FOR A ONE-COMPONENT CROSSLINKABLE COATING COMPOSITION

(71) Applicant: Arkema France, Colombes (FR)

(72) Inventors: Frank COGORDAN, Verneuil En Halatte (FR); Franck MORIERE, Verneuil En Halatte (FR); Fatoumata CAMARA, Verneuil En Halatte (FR)

(21) Appl. No.: 18/267,521

(22) PCT Filed: Dec. 22, 2021
(86) PCT No.: PCT/EP2021/087246

§ 371 Date: Jun. 15, 2023

(30) Foreign Application Priority Data
Dec. 22, 2020 (FR) FR2013930

(51) Int. Cl. C08L 33/10; C08K 5/00; C09D 7/20; C09D 7/80; C09D 133/08; C09D 133/10; C09D 133/26

(52) U.S. Cl. CPC C08L 33/10; C08K 5/0025; C09D 7/20; C09D 7/80; C09D 133/08; C09D 133/10; C09D 133/26; C08L 2201/50; C08L 2201/54

(57) ABSTRACT

The present invention relates to an organic resin, in particular acrylic, vinyl or acrylic-vinyl, of low molecular weight and functionalized with carboxyl and carbonyl groups, and also to an aqueous dispersion comprising said organic resin and a crosslinking agent, for the preparation of a one-component crosslinkable coating composition with a high level of performance.

### TECHNICAL FIELD

The present invention relates to an organic resin, in particular acrylic, vinyl or acrylic-vinyl, of low molecular weight and functionalized with carboxyl and carbonyl groups, and also to an aqueous dispersion comprising such a resin with a crosslinking agent, for the preparation of a one-component crosslinkable coating composition with a high level of performance. The invention is also directed to a process for the preparation of such a dispersion, to a one-component crosslinkable composition comprising such a dispersion, without the use of isocyanate or melamine, to a process for the preparation of a coating comprising a step of application of a one-component crosslinkable composition according to the invention, and finally to a substrate coated with a one-component crosslinkable composition according to the invention.

More particularly, the present invention relates to obtaining crosslinked coatings with a high level of performance from a one-component reactive system, not requiring subsequent mixing with a separate crosslinking agent of isocyanate or melamine type.

### PRIOR ART

It is already well known how to obtain crosslinked coatings from a two-component system in an organic solvent medium or in an aqueous medium in dispersion, from a resin functionalized with carboxyl groups by reaction with a polyisocyanate. The main drawback of these systems is linked to the use of isocyanate (polyisocyanate), an essential crosslinking agent for these crosslinked two-component systems. This use poses problems of toxicity, safety and harmfulness for human health and for the environment in general, problems which impose heavy constraints on their handling, even in an aqueous medium. Given their toxicity and their preparation from raw materials that are also toxic and harmful to the environment, this chemistry, based on the use of isocyanates, needs to be replaced by solutions that are less harmful to humans and the environment.

Furthermore, in addition to human health and environmental problems, the use of a crosslinkable isocyanate-based system is highly sensitive to the application conditions, whether in a solvent medium or in aqueous medium (even higher isocyanate consumption), with consumption of some of the isocyanate functions by the residual water in a solvent medium or by the water in aqueous medium with a stoichiometry which is difficult to control, having an effect on the reproducibility of the final performance characteristics and resulting in an overconsumption of isocyanates relative to the stoichiometry required. The consumption of isocyanates in the system by the ambient moisture or by the water in aqueous medium, with secondary reactions (decarboxylation and formation of polyamines converted into polyureas), may affect the structure and final performance characteristics of the coating. In particular, the release of CO₂ by reaction with water leads to the formation of bubbles of CO₂ (defects) in the final coating, in particular in the case of thick coatings. This is a significant limitation of conventional two-component systems based on isocyanate in terms of the maximum possible dry thickness without said defect (bubbles of CO₂) for a conventional polyurethane coating. This maximum dry thickness performance without said defect is called “the pitting limit”. In conventional two-component coating systems based on isocyanate, this maximum thickness is at best 70 μm. In the crosslinked products of the invention, these defects are not present, and thus there is no limitation.

More particularly, the present invention makes it possible, by a particular selection of the composition of the monomers and of the specific structure constituting the resin, to have a good ability to form aqueous dispersions which are stable on storage and which can be used in one-component form, i.e., without subsequent mixing with a crosslinking agent. Indeed, the high reactivity of isocyanates generally poses stability problems requiring the compositions to be stored in two-component form, due to the limited shelf life of the stocks and the ability of the NCO groups to react with atmospheric moisture. The present invention overcomes these drawbacks by proposing a one-component coating composition that is very easy to use for the end user because it can be crosslinked at room temperature, without a step of mixing with a separate crosslinking agent before application.

There is indeed a need for new resins, in particular acrylics, capable of forming stable one-component aqueous dispersions and allowing the formulation of aqueous coatings, and in particular of paints, varnishes, inks, adhesives and glues with low VOC content and fast drying at room temperature. The technical problem to be solved by the present invention therefore consists first of all in finding a specifically selected resin without the need to use isocyanates, bearing carboxyl and carbonyl groups, having a high solids content in an organic solvent medium, of low molecular weight, capable of forming a storage-stable aqueous dispersion, usable in one-component form, crosslinkable at room temperature, and having a low VOC content and a dry extract (solids content) ranging from 30 to 60%. This specific one-component system is easy to use, crosslinkable without any use of isocyanate, is therefore respectful of the environment and health, while presenting improved drying at room temperature, the appearance of the final coating obtained being homogeneous (defect-free) and exhibiting good mechanical performance, in particular in terms of hardness, chemical resistance and water resistance, while having a high level of gloss.

### DISCLOSURE OF THE INVENTION

The present invention therefore covers as a first subject a specific organic resin, a binder for crosslinkable compositions in an organic solvent medium or in aqueous medium, bearing carboxyl and carbonyl groups.

The second subject of the invention relates to an aqueous dispersion comprising a resin according to the invention, in combination with a crosslinking agent in water.

The third subject of the invention relates to a process for the preparation of an aqueous dispersion according to the invention.

A fourth subject of the invention is directed to the use of a resin or of an aqueous dispersion according to the invention in a one-component crosslinkable composition, and more particularly in a composition free of melamine or isocyanate crosslinking agent.

Another subject of the invention covers a one-component crosslinkable composition, comprising said resin or said aqueous dispersion of the invention.

The invention is also directed to a process for the preparation of a coating, comprising a step of application of a one-component crosslinkable composition according to the invention on a substrate.

Finally, the invention relates to a substrate coated with a one-component crosslinkable composition according to the invention.

Thus, the first subject of the present invention relates to an organic resin comprising:
a polymer P1, and
a polymer P2 functionalized with carboxyl groups,
said polymer P1 and/or said polymer P2 are functionalized with carbonyl groups, and preferably said polymer P1 and said polymer P2 are functionalized with carbonyl groups, and said resin has an acid number of between 10 and 50 mg KOH/g and a number-average molecular weight Mn of less than 25 000 g/mol.

In the organic resin of the invention, the polymers P1 and P2 are advantageously present in proportions by weight P1/P2 ranging from 90/10 to 60/40, and more advantageously from 80/20 to 70/30.

The polymers P1 and P2 are copolymerized with one another, preferably by radical polymerization. Thus, the polymers P1 and P2 are not simply mixed together. Specifically, the copolymerization between P1 and P2 enables the formation of a plurality of covalent bonds between the copolymers P1 and P2.

The organic resin according to the invention may in particular be a multiphase polymer. The expression “multiphase polymer” is understood to denote, within the meaning of the invention, a polymer having an inhomogeneous composition. The multiphase polymer may be obtained by a process of sequential polymerization in at least two steps starting from at least two compositions (or mixtures) of different monomers. In particular, the multiphase polymer may comprise at least two phases, a first phase S1 comprising the polymer P1 and a second phase S2 comprising the polymer P2, the phases S1 and S2 being coupled together by a plurality of covalent bonds. The first phase S1 may in particular correspond to a hydrophobic phase. The second phase S2 may in particular correspond to a hydrophilic phase, the hydrophilic character being provided by the presence of carboxyl functions.

The organic resin according to the invention may in particular be obtained by polymerizing the monomers constituting the polymer P2 in the presence of the polymer P1 and optionally of a radical initiator such as a peroxide. Thus, the growing chains generated during the polymerization of the polymer P2 can be grafted onto the fabricated, terminated chains of the polymer P1. In particular, the radical initiator may remove hydrogen atoms on these chains, thus forming radicals which may be combined to create covalent bonds between the polymers P1 and P2. According to this particular embodiment, the multiphase polymer obtained could be rearranged after emulsification, in water, so as to obtain a structure similar to a core/shell, the first polymer P1 forming the “core” and the second polymer P2 forming the “shell”. This “core/shell” designation should not, however, be interpreted as denoting a particle in which the “core” part is completely coated or encapsulated by a “shell” part, but as denoting a particle with a controlled morphology having two distinct phases.

The organic resin of the invention is functionalized by carboxyl and carbonyl groups. Within the meaning of the present invention, a carbonyl group is a ketone group or an aldehyde group.

According to one embodiment, the organic resin may comprise reactive functional groups other than the carboxyl and carbonyl groups, in particular hydroxyl groups. Alternatively, the organic resin of the invention does not comprise reactive functional groups other than the carboxyl and carbonyl groups.

More particularly, the polymer P2 is functionalized with carboxyl groups and the polymer P1 is not functionalized with carboxyl groups. The carboxyl group can be borne by an ethylenically unsaturated monomer functionalized by a carboxyl group. The presence of carboxyl group on P2 helps to disperse the resin in an aqueous phase. The absence of carboxyl groups in the polymer P1 can in particular improve the stability of the aqueous dispersion obtained with the resin.

More particularly, the polymer P1 and/or the polymer P2 are functionalized with carbonyl groups, and preferably the polymer P1 and the polymer P2 are both functionalized with carbonyl groups. The carbonyl group can be borne by an ethylenically unsaturated monomer functionalized by a carbonyl group, and preferably by an ethylenically unsaturated monomer functionalized by a ketone group, an aldehyde group, an acetoacetoxy group, an acetoacetamide group, or a diacetone group, and preferably diacetone (meth)acrylamide, 2-(acetoacetoxy)ethyl (meth)acrylate, 2-(acetoacetoxy)propyl (meth)acrylate, 3-(acetoacetoxy)propyl (meth)acrylate, 4-(acetoacetoxy)butyl (meth)acrylate, 2,3-di(acetoacetoxy)propyl (meth)acrylate, diacetone (meth)acrylate, acetonyl (meth)acrylate, allyl acetoacetates, vinyl acetoacetates, acetoacetamides, methyl vinyl ketone, ethyl vinyl ketone, butyl vinyl ketone, (meth)acrolein, crotonaldehyde, formylstyrene. Diacetone acrylamide (DAAM) is the preferred ethylenically unsaturated monomer functionalized by a carbonyl group.

For the purposes of the present invention, the expression “the polymer X bears a monomer Y” or “the polymer X comprises a monomer Y” means that the polymer X comprises a unit derived from the polymerization of a monomer Y. In other words, this means that the polymer X is obtained by polymerization of a composition comprising the monomer Y.

Within the meaning of the present invention, “a monomer functionalized by a diacetone group” means a monomer functionalized by a group originating from an aldolization between two molecules bearing a carbonyl group (for example between two molecules of acetone) in an acidic or basic medium. Preferably, a diacetone group corresponds to a group of formula —C(R¹R²)—CHR³—C(═O)—R⁴, in which R¹, R², R³ and R⁴ are independently selected from H and alkyl, preferably R³ is H and R¹, R² and R⁴ are methyl.

The ethylenically unsaturated monomer functionalized by a carbonyl group advantageously represents from 1 to 40%, and more advantageously from 5 to 30%, by weight of the total weight of the organic resin. For example, the ethylenically unsaturated monomer functionalized by a carbonyl group can represent from 2 to 40%, from 3 to 35%, from 5 to 30%, from 5 to 25% or from 5 to 20%, by weight of the total weight of the organic resin. In particular, the ethylenically unsaturated monomer functionalized by a carbonyl group can represent from 2 to 40%, from 3 to 35%, from 5 to 30%, from 5 to 25% or from 5 to 20%, by weight of the total weight of of the polymer P1. In particular, the ethylenically unsaturated monomer functionalized by a carbonyl group can represent from 2 to 40%, from 3 to 35%, from 5 to 30%, from 5 to 25% or from 5 to 20%, by weight of the total weight of the polymer P2.

For the purposes of the present invention, the expression “the monomer Y represents 1 to 20% by weight of the total weight of the resin Z (or of the polymer X)” means that the units derived from the polymerization of the “monomer Y represent 1 to 20% by weight of the total weight of the resin Z (or of the polymer X)”. In other words, this means that the resin Z (or the polymer X) are obtained by polymerization of a composition comprising 1 to 20% by weight of monomer Y relative to the total weight of the monomers in the composition.

According to another preferred embodiment, the polymers P1 and/or P2, and preferably both P1 and P2, are acrylic, vinyl and/or vinyl-acrylic copolymers, including styrene-acrylic copolymers.

Advantageously, the polymers P1 and/or P2, and preferably both P1 and P2, comprise at least one alkyl (meth)acrylate monomer, said alkyl preferably being C₁-C₂₄, more preferably C₁-C₁₄.

The term “alkyl (meth)acrylate monomer” can designate cyclic (cycloalkyl) and acyclic (non-cyclic alkyl) monomers without distinction. Thus, a C₁-C₂₄ alkyl (meth)acrylate monomer can correspond to a monomer of formula R⁶—O—C(═O)—CHR⁵=CH₂ in which R⁵ is H or methyl and R⁶ is an alkyl comprising 1 to 24 carbon atoms, the alkyl being able to be cyclic or acyclic. When R⁶ is a cyclic alkyl, R⁶ comprises at least 5 carbon atoms. An example of a cyclic alkyl (meth)acrylate monomer is isobornyl (meth)acrylate.

More advantageously, the polymers P1 and/or P2, and preferably both P1 and P2, comprise at least two distinct C₁-C₂₄ alkyl (meth)acrylate monomers. More advantageously still, the polymers P1 and/or P2, and preferably both P1 and P2, comprise at least two distinct C₁-C₁₄ alkyl (meth)acrylate monomers. Even more advantageously, the polymers P1 and/or P2, and preferably both P1 and P2, comprise at least three distinct C₁-C₂₄ alkyl (meth)acrylate monomers. Even more advantageously, the polymers P1 and/or P2, and preferably both P1 and P2, comprise at least three distinct C₁-C₁₄ alkyl (meth)acrylate monomers.

According to a particular embodiment, when the polymers P1 and/or P2, and preferably both P1 and P2, comprise at least two distinct C₁-C₂₄ alkyl (meth)acrylate monomers:
at least one of these monomers can be chosen from C₁-C₂ alkyl (meth)acrylate monomers, preferably methyl methacrylate; and
the other at least of these monomers can be chosen from C₄-C₂₄alkyl (meth)acrylate monomers, preferably butyl, lauryl, isodecyl, decyl, stearyl, 2-ethylhexyl, isooctyl, 2-octyl, isobornyl, 2-octyldecyl, 2-octyldodecyl or tridecyl (meth)acrylate, and more preferably butyl, lauryl or 2-ethylhexyl (meth)acrylate.

When the polymers P1 and/or P2, and preferably both P1 and P2, comprise at least two distinct C₁-C₁₄ alkyl (meth)acrylate monomers:
at least one of these monomers can be chosen from C₁-C₂ alkyl methacrylate monomers, preferably methyl methacrylate, and C₄-C₈ alkyl acrylate monomers, preferably butyl acrylate, and
the other at least of these monomers can be chosen from C₁₀-C₁₄ alkyl (meth)acrylate monomers, preferably lauryl, isodecyl, decyl, stearyl, 2-ethylhexyl, isooctyl, 2-octyl, 2-octyldecyl, 2-octyldodecyl or tridecyl (meth)acrylate, and more preferably lauryl methacrylate and 2-ethylhexyl acrylate.

According to a particular embodiment, the polymers P1 and/or P2, and preferably both P1 and P2, comprise at least two distinct C₁-C₂₄ alkyl (meth)acrylate monomers comprising the following monomer units:
at least one C₁-C₂ alkyl (meth)acrylate monomer, preferably methyl methacrylate,
at least one C₄-C₈ alkyl (meth)acrylate monomer, preferably chosen from butyl, 2-ethylhexyl, isooctyl or 2-octyl (meth)acrylate, more preferably butyl or 2-ethylhexyl (meth)acrylate.

According to a particular embodiment, the polymers P1 and/or P2, and preferably both P1 and P2, comprise at least two distinct C₁-C₂₄ alkyl (meth)acrylate monomers comprising the following monomer units:
at least one C₁-C₂ alkyl (meth)acrylate monomer, preferably methyl methacrylate,
at least one C₄-C₆ alkyl (meth)acrylate monomer, preferably chosen from butyl (meth)acrylate.

According to a particular embodiment, the polymers P1 and/or P2, and preferably both P1 and P2, comprise the following monomer units:
at least one C₁-C₂ alkyl (meth)acrylate monomer, preferably methyl methacrylate,
at least one C₄-C₈ alkyl (meth)acrylate monomer, preferably chosen from butyl, 2-ethylhexyl, isooctyl or 2-octyl (meth)acrylate, more preferably butyl or 2-ethylhexyl (meth)acrylate;
optionally at least one C₁₀-C₂₄ alkyl (meth)acrylate, preferably lauryl, isodecyl, decyl, stearyl, isobornyl, 2-octyldecyl, 2-octyldodecyl or tridecyl (meth)acrylate, and more preferably lauryl (meth)acrylate.

According to a particular embodiment, the polymers P1 and/or P2, and preferably both P1 and P2, comprise the following monomer units:
at least one C₁-C₂ alkyl (meth)acrylate monomer, preferably methyl methacrylate,
at least one C₄-C₆ alkyl (meth)acrylate monomer, preferably chosen from butyl (meth)acrylate,
optionally at least one C₈-C₂₄ alkyl (meth)acrylate, preferably lauryl, isodecyl, decyl, stearyl, 2-ethylhexyl, isooctyl, 2-octyl, isobornyl, 2-octyldecyl, 2-octyldodecyl or tridecyl (meth)acrylate, and more preferably lauryl (meth)acrylate.

According to a particular embodiment, the polymers P1 and/or P2, and preferably both P1 and P2, comprise at least three distinct C₁-C₂₄ alkyl (meth)acrylate monomers comprising the following monomer units:
at least one C₁-C₂ alkyl (meth)acrylate monomer, preferably methyl methacrylate,
at least one C₄-C₈ alkyl (meth)acrylate monomer, preferably butyl, 2-ethylhexyl, isooctyl or 2-octyl (meth)acrylate,
at least one C₁₀-C₂₄ alkyl (meth)acrylate monomer, preferably chosen from lauryl, isodecyl, decyl, stearyl, isobornyl, 2-octyldecyl, 2-octyldodecyl or tridecyl (meth)acrylate, and more preferably lauryl (meth)acrylate.

According to a particular embodiment, the polymers P1 and/or P2, and preferably both P1 and P2, comprise at least three distinct C₁-C₂₄ alkyl (meth)acrylate monomers comprising the following monomer units:
at least one C₁-C₂ alkyl (meth)acrylate monomer, preferably methyl methacrylate,
at least one C₄-C₆ alkyl (meth)acrylate monomer, preferably butyl (meth)acrylate,
at least one C₅-C₂₄alkyl (meth)acrylate monomer, preferably chosen from lauryl, isodecyl, decyl, stearyl, 2-ethylhexyl, isooctyl, 2-octyl, isobornyl, 2-octyldecyl, 2-octyldodecyl or tridecyl (meth)acrylate, and more preferably lauryl or 2-ethylhexyl (meth)acrylate.

Advantageously, the polymers P1 and/or P2, and preferably both P1 and P2, comprise at least three distinct C₁-C₁₄ alkyl (meth)acrylate monomers comprising the following monomer units:
at least one C₁-C₂ alkyl methacrylate monomer, preferably methyl methacrylate,
at least one C₄-C₈ alkyl acrylate monomer, preferably butyl acrylate,
at least one C₁₀-C₁₄ alkyl (meth)acrylate monomer, preferably chosen from lauryl, isodecyl, decyl, stearyl, 2-ethylhexyl, isooctyl, 2-octyl, 2-octyldecyl, 2-octyldodecyl or tridecyl (meth)acrylate, and more preferably lauryl methacrylate and 2-ethylhexyl acrylate.

The total weight of alkyl (meth)acrylate monomer advantageously represents from 20 to 90%, more advantageously from 30 to 80%, even more advantageously from 40 to 70%, of the total weight of the organic resin. According to a first embodiment, the total weight of alkyl (meth)acrylate monomer can represent from 20 to 60%, 25 to 55%, from 30 to 50% or from 35 to 45%, of the total weight of the organic resin. According to a second embodiment, the total weight of alkyl (meth)acrylate monomer can represent from 50 to 90%, from 55 to 85%, from 60 to 80% or from 65 to 75%, of the total weight of the organic resin. The first embodiment may in particular correspond to the % by weight of alkyl (meth)acrylate monomer in an acrylic resin (that is to say a resin not comprising vinyl monomer such as styrene). The second embodiment may in particular correspond to the % by weight of alkyl (meth)acrylate monomer in a vinyl-acrylic resin (that is to say a resin comprising a vinyl monomer such as styrene).

In particular, the total weight of alkyl (meth)acrylate monomer can represent from 20 to 90%, more advantageously from 30 to 80%, more advantageously still from 40 to 70%, of the total weight of the polymer P1. According to a first embodiment, the total weight of alkyl (meth)acrylate monomer can represent from 20 to 60%, 25 to 55%, from 30 to 50% or from 35 to 45%, of the total weight of the polymer P1. According to a second embodiment, the total weight of alkyl (meth)acrylate monomer can represent from 50 to 90%, from 55 to 85%, from 60 to 80% or from 65 to 75%, of the total weight of the polymer P1. The first embodiment may in particular correspond to the % by weight of alkyl (meth)acrylate monomer in an acrylic polymer (that is to say a polymer not comprising vinyl monomer such as styrene). The second embodiment may in particular correspond to the % by weight of alkyl (meth)acrylate monomer in a vinyl-acrylic polymer (that is to say a polymer comprising a vinyl monomer such as styrene).

In particular, the total weight of alkyl (meth)acrylate monomer can represent from 20 to 90%, more advantageously from 30 to 80%, more advantageously still from 40 to 70%, of the total weight of the polymer P2. According to a first embodiment, the total weight of alkyl (meth)acrylate monomer can represent from 20 to 60%, 25 to 55%, from 30 to 50% or from 35 to 45%, of the total weight of the polymer P2. According to a second embodiment, the total weight of alkyl (meth)acrylate monomer can represent from 50 to 90%, from 55 to 85%, from 60 to 80% or from 65 to 75%, of the total weight of the polymer P2. The first embodiment may in particular correspond to the % by weight of alkyl (meth)acrylate monomer in an acrylic polymer. The second embodiment may in particular correspond to the % by weight of alkyl (meth)acrylate monomer in a vinyl-acrylic polymer.

The polymers P1 and/or P2, and preferably both P1 and P2, may optionally comprise at least one aromatic vinyl monomer, preferably chosen from styrene and its derivatives including vinyltoluenes (ortho, meta, para), α-methylstyrene, tert-butylstyrene, para-butylstyrene, para-decylstyrene, and more preferentially styrene.

The polymer P2 also comprises at least one ethylenically unsaturated monomer functionalized by a carboxyl group. In particular, the polymer P2 comprises at least 1%, preferably at least 2%, more preferably at least 5%, even more preferably at least 8% by weight of ethylenically unsaturated monomer functionalized by a carboxyl group.

According to a preferred embodiment, the polymer P1 is free of ethylenically unsaturated monomer functionalized by a carboxyl group.

The term “carboxyl group” means a —COOH group and its derivatives. The carboxylic acid derivatives are groups which can generate one or two —COOH groups by hydrolysis, in particular the anhydrides (—C(═O)—O—C(═O)—). The anhydrides may be linear or cyclic.

The term “X is free of Y” means that X contains less than 0.1%, in particular less than 0.05%, more particularly less than 0.01%, even more particularly 0% by weight of Y relative to the weight of X.

Advantageously, the ethylenically unsaturated monomer functionalized by a carboxyl group is chosen from the monomers (meth)acrylic acid, itaconic acid and anhydride, maleic acid and anhydride, fumaric acid, crotonic acid and anhydride, tetrahydrophthalic acid and anhydride, and preferably (meth)acrylic acid.

According to a particular option, the polymer P1 and/or the polymer P2, and preferably the polymer P2, can be functionalized with hydroxyl groups. The polymer P1 and/or the polymer P2, and preferably the polymer P2, can comprise an ethylenically unsaturated monomer bearing at least one hydroxyl group, preferably a C₂-C₄ hydroxyalkyl (meth)acrylate monomer, and more preferably hydroxyethyl acrylate.

According to a preferred embodiment, the polymer P1 is a copolymer A comprising the following monomer units:
a1) at least one C₁-C₂ alkyl (meth)acrylate monomer, preferably methyl methacrylate, and/or
a2) at least one C₄-C₈ alkyl (meth)acrylate monomer, preferably butyl, 2-ethylhexyl, isooctyl or 2-octyl (meth)acrylate,
a3) optionally at least one C₁₀-C₂₄ alkyl (meth)acrylate monomer, preferably chosen from lauryl, isodecyl, decyl, stearyl, isobornyl, 2-octyldecyl, 2-octyldodecyl or tridecyl (meth)acrylate, and more preferably lauryl (meth)acrylate,
a4) optionally at least one aromatic vinyl monomer, preferably chosen from styrene and its derivatives comprising vinyltoluenes (ortho, meta, para), α-methylstyrene, tert-butylstyrene, para-butylstyrene, para-decylstyrene, and more preferably styrene,
a5) at least one ethylenically unsaturated monomer functionalized by a carbonyl group, preferably an ethylenically unsaturated monomer functionalized by a ketone group, an aldehyde group, an acetoacetoxy group, an acetoacetamide group or a diacetone group, more preferably diacetone (meth)acrylamide, 2-(acetoacetoxy)ethyl (meth)acrylate, 2-(acetoacetoxy)propyl (meth)acrylate, 3-(acetoacetoxy)propyl (meth)acrylate, 4-(acetoacetoxy)butyl (meth)acrylate, 2,3-di(acetoacetoxy)propyl (meth)acrylate, diacetone (meth)acrylate, acetonyl (meth)acrylate, allyl acetoacetates, vinyl acetoacetates, acetoacetamides, methyl vinyl ketone, ethyl vinyl ketone, butyl vinyl ketone, (meth)acrolein, crotonaldehyde, formylstyrene, and even more preferably diacetone acrylamide (DAAM), and
a6) optionally, at least one C₂-C₄ hydroxyalkyl (meth)acrylate monomer, preferably hydroxyethyl acrylate.

According to a preferred embodiment, the polymer P2 is a copolymer B comprising the following monomer units:
b1) at least C₁-C₂ alkyl (meth)acrylate monomer, preferably methyl methacrylate, and/or
b2) at least one C₄-C₈alkyl (meth)acrylate monomer, preferably butyl, 2-ethylhexyl, isooctyl or 2-octyl (meth)acrylate,
b3) optionally at least one C₁₀-C₂₄ alkyl (meth)acrylate monomer, preferably chosen from lauryl, isodecyl, decyl, stearyl, isobornyl, 2-octyldecyl, 2-octyldodecyl or tridecyl (meth)acrylate, and even more preferably lauryl (meth)acrylate,
b4) at least one aromatic vinyl monomer, preferably chosen from styrene and its derivatives comprising vinyltoluenes (ortho, meta, para), α-methylstyrene, tert-butylstyrene, para-butylstyrene, para-decylstyrene, and even more preferably styrene,
b5) at least one ethylenically unsaturated monomer functionalized by a carbonyl group, preferably an ethylenically unsaturated monomer functionalized by a ketone group, an aldehyde group, an acetoacetoxy group, an acetoacetamide group, or a diacetone group, more preferably diacetone (meth)acrylamide, 2-(acetoacetoxy)ethyl (meth)acrylate, 2-(acetoacetoxy)propyl (meth)acrylate, 3-(acetoacetoxy)propyl (meth)acrylate, 4-(acetoacetoxy)butyl (meth)acrylate, 2,3-di(acetoacetoxy)propyl (meth)acrylate, diacetone (meth)acrylate, acetonyl (meth)acrylate, allyl acetoacetates, vinyl acetoacetates, acetoacetamides, methyl vinyl ketone, ethyl vinyl ketone, butyl vinyl ketone, (meth)acrolein, crotonaldehyde, formylstyrene, and even more preferably diacetone acrylamide (DAAM),
b6) at least one ethylenically unsaturated monomer functionalized by a carboxyl group, preferably chosen from the monomers (meth)acrylic acid, itaconic acid and anhydride, maleic acid and anhydride, fumaric acid, crotonic acid and anhydride, tetrahydrophthalic acid and anhydride, preferably (meth)acrylic acid, and
b7) optionally at least one C₂-C₄ hydroxyalkyl (meth)acrylate monomer, preferably hydroxyethyl acrylate.

According to a preferred embodiment, the polymer P1 is a copolymer A′ comprising the following monomer units:
a′1) at least one C₁-C₂ alkyl (meth)acrylate monomer, preferably methyl methacrylate, and/or
a′2) at least one C₄-C₆ alkyl (meth)acrylate monomer, preferably butyl (meth)acrylate,
a′3) optionally at least one C₈-C₂₄ alkyl (meth)acrylate monomer, preferably chosen from lauryl, isodecyl, decyl, stearyl, 2-ethylhexyl, isooctyl, 2-octyl, isobornyl, 2-octyldecyl, 2-octyldodecyl or tridecyl (meth)acrylate, and more preferably lauryl or 2-ethylhexyl (meth)acrylate,
a′4) optionally at least one aromatic vinyl monomer, preferably chosen from styrene and its derivatives including vinyltoluenes (ortho, meta, para), α-methylstyrene, tert-butylstyrene, para-butylstyrene, para-decylstyrene, and more preferably styrene,
a′5) at least one ethylenically unsaturated monomer functionalized by a carbonyl group, preferably an ethylenically unsaturated monomer functionalized by a ketone group, an aldehyde group, an acetoacetoxy group, an acetoacetamide group or a diacetone group, more preferably diacetone (meth)acrylamide, 2-(acetoacetoxy)ethyl (meth)acrylate, 2-(acetoacetoxy)propyl (meth)acrylate, 3-(acetoacetoxy)propyl (meth)acrylate, 4-(acetoacetoxy)butyl (meth)acrylate, 2,3-di(acetoacetoxy)propyl (meth)acrylate, diacetone (meth)acrylate, acetonyl (meth)acrylate, allyl acetoacetates, vinyl acetoacetates, acetoacetamides, methyl vinyl ketone, ethyl vinyl ketone, butyl vinyl ketone, (meth)acrolein, crotonaldehyde, formylstyrene, and even more preferably diacetone acrylamide (DAAM), and
a′6) optionally, at least one C₂-C₄ hydroxyalkyl (meth)acrylate monomer, preferably hydroxyethyl acrylate.

According to a preferred embodiment, the polymer P2 is a copolymer B′ comprising the following monomer units:
b′1) at least one C₁-C₂ alkyl (meth)acrylate monomer, preferably methyl methacrylate and/or
b′2) at least one C₄-C₆ alkyl (meth)acrylate monomer, preferably butyl (meth)acrylate,
b′3) optionally at least one C₈-C₂₄ alkyl (meth)acrylate monomer, preferably chosen from lauryl, isodecyl, decyl, stearyl, 2-ethylhexyl, isooctyl, isobornyl, 2-octyl, 2-octyldecyl, 2-octyldodecyl or tridecyl (meth)acrylate, and even more preferably lauryl (meth)acrylate,
b′4) at least one aromatic vinyl monomer, preferably chosen from styrene and its derivatives including vinyltoluenes (ortho, meta, para), α-methylstyrene, tert-butylstyrene, para-butylstyrene, para-decylstyrene, and even more preferably styrene,
b′5) at least one ethylenically unsaturated monomer functionalized by a carbonyl group, preferably an ethylenically unsaturated monomer functionalized by a ketone group, an aldehyde group, an acetoacetoxy group, an acetoacetamide group, or a diacetone group, more preferably diacetone (meth)acrylamide, 2-(acetoacetoxy)ethyl (meth)acrylate, 2-(acetoacetoxy)propyl (meth)acrylate, 3-(acetoacetoxy)propyl (meth)acrylate, 4-(acetoacetoxy)butyl (meth)acrylate, 2,3-di(acetoacetoxy)propyl (meth)acrylate, diacetone (meth)acrylate, acetonyl (meth)acrylate, allyl acetoacetates, vinyl acetoacetates, acetoacetamides, methyl vinyl ketone, ethyl vinyl ketone, butyl vinyl ketone, (meth)acrolein, crotonaldehyde, formylstyrene, and even more preferably diacetone acrylamide (DAAM),
b′6) at least one ethylenically unsaturated monomer functionalized by a carboxyl group, preferably chosen from the monomers (meth)acrylic acid, itaconic acid and anhydride, maleic acid and anhydride, fumaric acid, crotonic acid and anhydride, tetrahydrophthalic acid and anhydride, preferably (meth)acrylic acid, and
b′7) optionally at least one C₂-C₄ hydroxyalkyl (meth)acrylate monomer, preferably hydroxyethyl acrylate.

According to a preferred embodiment, the polymer P1 is a copolymer A″ comprising the following monomer units:
a″1) at least one C₁-C₂ alkyl methacrylate monomer, preferably methyl methacrylate, and/or
a″2) at least one C₄-C₈ alkyl acrylate monomer, preferably butyl acrylate, and/or
a″3) at least one C₁₀-C₁₄ alkyl (meth)acrylate monomer, preferably chosen from lauryl, isodecyl, decyl, stearyl, 2-ethylhexyl, isooctyl, 2-octyl, 2-octyldecyl, 2-octyldodecyl or tridecyl (meth)acrylate, and more preferably lauryl methacrylate and 2-ethylhexyl acrylate,
a″4) optionally at least one aromatic vinyl monomer, preferably chosen from styrene and its derivatives including vinyltoluenes (ortho, meta, para), α-methylstyrene, tert-butylstyrene, para-butylstyrene, para-decylstyrene, and more preferably styrene, a″5) at least one ethylenically unsaturated monomer functionalized by a carbonyl group, preferably an ethylenically unsaturated monomer functionalized with a ketone group, an aldehyde group, an acetoacetoxy group, an acetoacetamide group, or a diacetone group, more preferably diacetone (meth)acrylamide, 2-(acetoacetoxy)ethyl (meth)acrylate, 2-(acetoacetoxy)propyl (meth)acrylate, 3-(acetoacetoxy)propyl (meth)acrylate, 4-(acetoacetoxy)butyl (meth)acrylate, 2,3-di(acetoacetoxy)propyl (meth)acrylate, diacetone (meth)acrylate, acetonyl (meth)acrylate, allyl acetoacetates, vinyl acetoacetates, acetoacetamides, methyl vinyl ketone, ethyl vinyl ketone, butyl vinyl ketone, (meth)acrolein, crotonaldehyde, formylstyrene, and even more preferably diacetone acrylamide (DAAM), and
a″6) optionally, at least one C₂-C₄ hydroxyalkyl (meth)acrylate monomer, preferably hydroxyethyl acrylate.

According to a preferred embodiment, the polymer P2 is a copolymer B″ comprising the following monomer units:
b″1) at least one C₁-C₂ alkyl methacrylate monomer, preferably methyl methacrylate and/or
b″2) at least one C₄-C₈ alkyl acrylate monomer, preferably butyl acrylate, and/or
b″3) at least one C₁₀-C₁₄ alkyl (meth)acrylate monomer, preferably chosen from lauryl, isodecyl, decyl, stearyl, 2-ethylhexyl, isooctyl, 2-octyl, 2-octyldecyl, 2-octyldodecyl or tridecyl (meth)acrylate, and even more preferably lauryl methacrylate and 2-ethylhexyl acrylate,
b″4) at least one aromatic vinyl monomer, preferably chosen from styrene and its derivatives including vinyltoluenes (ortho, meta, para), α-methylstyrene, tert-butylstyrene, para-butylstyrene, para-decylstyrene, and even more preferably styrene,
b″5) at least one ethylenically unsaturated monomer functionalized by a carbonyl group, preferably an ethylenically unsaturated monomer functionalized with a ketone group, an aldehyde group, an acetoacetoxy group, an acetoacetamide group, or a diacetone group, more preferably diacetone (meth)acrylamide, 2-(acetoacetoxy)ethyl (meth)acrylate, 2-(acetoacetoxy)propyl (meth)acrylate, 3-(acetoacetoxy)propyl (meth)acrylate, 4-(acetoacetoxy)butyl (meth)acrylate, 2,3-di(acetoacetoxy)propyl (meth)acrylate, diacetone (meth)acrylate, acetonyl (meth)acrylate, allylacetoacetates, vinyl acetoacetates, acetoacetamides, methyl vinyl ketone, ethyl vinyl ketone, butyl vinyl ketone, (meth)acrolein, crotonaldehyde, formylstyrene, and even more preferentially diacetone acrylamide (DAAM),
b″6) at least one ethylenically unsaturated monomer functionalized with a carboxyl group, preferably chosen from the monomers (meth)acrylic acid, itaconic acid and anhydride, maleic acid and anhydride, fumaric acid, crotonic acid and anhydride, tetrahydrophthalic acid and anhydride, preferably (meth)acrylic acid, and
b″7) optionally, at least one C₂-C₄ hydroxyalkyl (meth)acrylate monomer, preferably hydroxyethyl acrylate.

According to a preferred embodiment, the polymer P1 can be a polymer A as defined above and the polymer P2 can be a polymer B as defined above. Alternatively, the polymer P1 can be a polymer A′ as defined above and the polymer P2 can be a polymer B′ as defined above. Alternatively, the polymer P1 can be a polymer A″ as defined above and the polymer P2 can be a polymer B″ as defined above.

The monomer a1), a′1), a″1), b1), b′1) and/or b″1) can represent from 5 to 60%, and preferably from 10 to 50%, by weight of the total weight of the organic resin. The monomer a1), a′1) or a″1) can represent from 5 to 40%, and preferably from 10 to 30%, by weight of the total weight of the polymer P1. The monomer b1), b′1) or b″1) can represent from 2 to 30%, and preferably from 5 to 20%, by weight of the total weight of the polymer P2. The total weight of a1) and b1) or the total weight of a′1) and b′1) or the total weight of a″1) and b″1) can represent from 5 to 40%, and preferably from 10 to 30%, of the total weight of the organic resin (that is to say of the total weight of P1+P2).

The monomer a2), a′2), a″2), b2), b′2) and/or b″2) can represent from 5 to 40%, and preferably from 10 to 30%, by weight of the total weight of the organic resin. The monomer a2), a′2) or a″2) can represent from 5 to 40%, and preferably from 10 to 30%, by weight of the total weight of the polymer P1. The monomer b2), b′2) or b″2) can represent from 10 to 50%, and preferably from 20 to 40%, by weight of the total weight of the polymer P2. The total weight of a2) and b2) or the total weight of a′2) and b′2) or the total weight of a″2) and b″2) can represent from 5 to 40%, and preferably from 10 to 30%, of the total weight of the organic resin (that is to say of the total weight of P1+P2).

The monomer a3), a′3), a″3), b3), b′3) and/or b″3) can represent from 1 to 20%, and preferably from 1 to 10%, by weight of the total weight of the organic resin. The monomer a3), a′3) or a″3) can represent from 0 to 10%, and preferably from 1 to 8%, by weight of the total weight of the polymer P1. The monomer b3), b′3) or b″3) can represent from 0 to 10%, and preferably from 1 to 8%, by weight of the total weight of the polymer P2. The total weight of a3) and b3) or the total weight of a′3) and b′3) or the total weight of a″3) and b″3) can represent from 0 to 10%, and preferably from 2 to 8%, of the total weight of the organic resin (that is to say of the total weight of P1+P2).

The monomer a4), a′4), a″4), b4), b′4) and/or b″4) can represent from 0 to 50%, and preferably from 10 to 40%, by weight of the total weight of the organic resin. The monomer a4), a′4) or a″4) can represent from 10 to 50%, and preferably from 20 to 40%, by weight of the total weight of the polymer P1. The monomer b4), b′4) or b″4) can represent from 5 to 40%, and preferably from 10 to 30%, by weight of the total weight of the polymer P2. The total weight of a4) and b4) or the total weight of a′4) and b′4) or the total weight of a″4) and b″4) can represent from 10 to 50%, and preferably from 20 to 40%, of the total weight of the organic resin (that is to say of the total weight of P1+P2).

The monomer a5), a'S), a″5), b5), b'S) and/or b″5) can represent from 1 to 40%, and preferably from 5 to 30%, by weight of the total weight of the organic resin. The monomer a5), a'S) or a″5) can represent from 5 to 30%, and preferably from 10 to 25%, by weight of the total weight of the polymer P1. The monomer b5), b′5) or b″5) can represent from 5 to 30%, and preferably from 10 to 25%, by weight of the total weight of the polymer P2. The total weight of a5) and b5) or the total weight of a'S) and b'S) or the total weight of a″5) and b″5) can represent from 5 to 30%, and preferably from 10 to 25%, of the total weight of the organic resin (that is to say of the total weight of P1+P2).

The monomer b6), b′6) and/or b″6) can represent from 0.5 to 15%, and preferably from 1 to 10%, by weight of the total weight of the organic resin. The monomer b6), b′6) or b″6) can represent from 1 to 20%, and preferably from 5 to 15%, by weight of the total weight of the polymer P2. The total weight of b6) or the total weight of b′6) or the total weight of b″6) can represent from 0.5 to 15%, and preferably from 1 to 10%, of the total weight of the organic resin (that is to say of the total weight of P1+P2).

The monomer a6), a′6), a″6), b7), b′7) and/or b″7) can represent from 0 to 30%, and preferably from 5 to 25%, by weight of the total weight of the organic resin. The monomer a6), a′6) or a″6) can represent from 0 to 30%, and preferably from 0 to 20%, by weight of the total weight of the polymer P1. The monomer b7), b′7) or b″7) can represent from 0 to 30%, and preferably from 0 to 20%, by weight of the total weight of the polymer P2. The total weight of a6) and b7) or the total weight of a′6) and b′7) or the total weight of a″6) and b″7) can represent from 0 to 30%, and preferably from 0 to 20%, of the total weight of the organic resin (that is to say of the total weight of P1+P2).

The polymers P1 and/or P2 may comprise other optional monomers present to adjust the final performance characteristics of the resin depending on its use. They are different from the monomers described previously and can bear different functional groups than said monomers. However, these other optional monomers do not bear any group capable of reacting with a functional group of another component monomer of said resin, any crosslinking reaction in the preparation of said resin being excluded.

This means that the composition of the resin is chosen such that no internal (crosslinking) reaction can take place between two component monomers of said resin. In fact, no internal crosslinking reaction in said resin should take place due to a single monomer or due to two or more monomers which are reactive with one another. Specifically, by definition, said resin is soluble in an organic medium and therefore cannot be in crosslinked form in its internal structure. The expression “resin soluble in an organic medium” means that said resin has no crosslinked structure, in which case (if crosslinked) it would be insoluble in any solvent (organic medium). More precisely, the fact that said resin is soluble means that it has a linear or branched structure, which cannot be crosslinked, and which is therefore soluble in an organic medium.

According to a preferred embodiment, the resin according to the invention is soluble at 20° C. in a glycol ether, such as butoxyethanol, Dowanol® DPnB or Dowanol® DPM. The solubility of a resin in an organic solvent at 20° C. can in particular be evaluated according to the % by weight of insoluble fraction at 20° C. of a composition consisting of 80% by weight of resin and 20% by weight of said organic solvent relative to the weight of the composition. Thus, a resin is said to be soluble at 20° C. in an organic solvent if the insoluble fraction of said composition is less than 5% by weight, preferably less than 2.5% by weight, more preferably less than 2% by weight, relative to the total weight of resin introduced into the composition. In general, if said composition is a clear solution at 20° C. (that is to say a homogeneous liquid with no sedimentation visible to the naked eye), then it is considered that the insoluble fraction is less than 5% by weight and that the resin is soluble in the solvent tested.

The polymer P1 is advantageously a hydrophobic polymer, and the polymer P2 is advantageously a hydrophilic polymer. The polymer P2 is therefore advantageously more hydrophilic than the polymer P1.

For the purposes of the invention, a “hydrophobic” polymer is understood to mean a polymer comprising hydrophobic monomers, that is to say having little affinity with water or which is sparingly soluble in water. One method for estimating this hydrophobicity is that of measuring the partition coefficient of the substance to be evaluated, between octanol and water, with the hydrophobicity expressed as a logarithm of this partition coefficient. The hydrophobicity value log Kow for a monomer is an estimation calculated from the logarithm of the partition coefficient (log P) between octanol and water, via the method of contribution of the atoms and the structural fragments of the molecule, using for this estimation the EPI (Estimation Program Interface) Suite® known as the KowWin software from SRC (Syracuse Research Corporation). The method and program epi v4.11 used for this calculation (estimation) of log Kow for the monomers are available at the address http://www.epa.gov/oppt/exposure/pubs/episuite.htm. This methodology was described by W. M. Meylan and P. H. Howard in 1995 in “Atom/fragment contribution method for estimating octanol-water partition coefficients” in Pharm. Sci. 84: 83-92. The partition coefficient P corresponds to the ratio of the chemical concentration in the octanol phase relative to the chemical concentration in the aqueous phase in a system with two phases in equilibrium. As regards a copolymer, in particular such as a resin defined according to the invention, the overall hydrophobicity value according to the invention based on the logarithm of the octanol/water partition coefficient is defined as being the mean weight value relative to all of the component monomers of the resin and it is in particular estimated by the mean weight relative to all of the component monomers, from the individual log Kow values calculated via the KowWin method, as described above.

Thus, the difference in hydrophobicity between P1 and P2, expressed as logarithm of the octanol/water partition coefficient, in particular as log Kow according to the KowWin method described above, is at least 0.15 units, and preferably at least 0.25 units, and even more preferentially at least 0.30 units, and P1 having an acid number of zero or significantly zero or significantly lower than that of P2.

According to a particular embodiment of the invention, the polymer P1 and the polymer P2 have respective glass transition temperatures Tg1 and Tg2, measured by DSC (10° C./min 2 passages), as follows:
Tg1 ranging from 0 to 80° C., and preferably ranging from 40 to 60° C., and
Tg2 ranging from 0 to 80° C., and preferably ranging from 5 to 30° C. Advantageously, the polymer P1 has a higher Tg than the polymer P2, in particular higher by at least 5° C. and preferably higher by at least 10° C. than the Tg of the polymer P2.

According to a particular embodiment of the invention, the polymer P1 and the polymer P2 have respective glass transition temperatures Tg1 and Tg2, measured by DSC (10° C./min 2 passages), as follows:
Tg1 ranging from 0 to 80° C., and preferably ranging from 5 to 30° C., and
Tg2 ranging from 0 to 80° C., and preferably ranging from 40 to 60° C. Advantageously, the polymer P2 has a higher Tg than the polymer P1, in particular higher by at least 5° C. and preferably higher by at least 10° C. than the Tg of the polymer P1.

The resin of the invention has an acid number ranging from 10 to 50 mg KOH/g, and preferably ranging from 15 to 30 mg KOH/g.

The resin of the invention preferably has a number-average molecular weight Mn, measured by GPC (in polystyrene equivalent, in THF) ranging from 1,000 to 20,000 g/mol, preferably from 1,000 to 15,000 g/mol, more preferably from 1,500 to 10,000 g/mol, and even more preferably from 1,500 to 7,000 g/mol.

The resin of the invention preferably has a weight-average molecular weight Mw, measured by size exclusion chromatography, ranging from 5,000 to 50,000 g/mol, and preferably from 8,000 to 20,000 g/mol. For example, the resin of the invention may have a weight-average molecular weight Mw ranging from 6,000 to 40,000 g/mol, from 8,000 to 30,000 g/mol or from 10,000 to 20,000 g/mol.

The resin of the invention may be in the form of a solution in at least one organic diluent, preferably a polar organic diluent, having a weight content of resin ranging from 70 to 98%, and preferably ranging from 80 to 95%. Thus, the organic diluent preferably bears at least one polar group. Mention may be made, as suitable examples of such diluents, of those comprising ester, ether, sulfoxide, amide, alcohol, ketone or aldehyde groups. The organic diluent is preferably chosen from glycol ethers, and more preferentially from ethylene glycol, propylene glycol, dipropylene glycol, and butyl glycol. Said diluent must not react with the functional groups borne by the resin of the invention.

The resin of the invention is advantageously self-dispersible in water after neutralization, without the need for addition of surfactant or dispersant. The term “self-dispersible resin” means a resin capable of dispersing spontaneously in a basic aqueous phase under gentle stirring. This ability is in particular due to the presence of ionizable groups on the resin, more particularly to the presence of carboxyl groups which can be neutralized by addition of a base.

The second subject of the invention relates to an aqueous resin dispersion, which dispersion comprises at least one resin as defined according to the invention in a form dispersed in water and a crosslinking agent, said crosslinking agent preferably being functionalized with at least two —NH₂ or —NH groups, and more preferably with at least two hydrazide groups —C(═O)—NH—NH₂. The crosslinking agent present in the aqueous resin dispersion of the invention is advantageously different from a melamine or isocyanate crosslinking agent.

The crosslinking agent present in the aqueous resin dispersion of the invention is preferably chosen from a dihydrazide such as adipic acid dihydrazide, oxalic acid dihydrazide, malonic acid dihydrazide, succinic acid dihydrazide, glutaric acid dihydrazide, pimelic acid dihydrazide, suberic acid dihydrazide, azelaic acid dihydrazide, sebacic acid dihydrazide, dodecanedioic acid dihydrazide, docosanedioic acid dihydrazide, isophthalic acid dihydrazide, maleic hydrazide and carbohydrazide; a polyhydrazide such as polyacrylic polyhydrazide; hydrazine; a dihydrazone; an aliphatic, cycloaliphatic or aromatic polyamine such as ethylene diamine, 1,2-diaminopropane, 1,3-diaminopropane, 1,2-diaminobutane, 1,3-diaminobutane, 1,4-diaminobutane, 1,5-pentamethylenediamine, 1,6-hexamethylenediamine, 1,8-octamethylenediamine, 1,12-dodecamethylenediamine, 2,2-dimethyl-1,3-propanediamine, 2-butyl-2-ethyl-1,5-pentanediamine, isophorone diamine, 1,2-, 1,3- or 1,4-diaminocyclohexane, 2-methylcyclohexane-1,3-diamine, 4-methylcyclohexane-1,3-diamine, 1,2-, 1,3- or 1,4-bis(aminomethyl)cyclohexane, diaminodecahydronaphthalene, 3,3′-dimethyl-4,4′-diaminodicyclohexylmethane, 4,4′-diaminodicyclohexylmethane, bis(aminomethyl) norbornane, piperazine, meta- and para-phenylenediamine, meta- and para-xylylenediamine, meta- and para-tolylenediamine, 3,4′-diaminodiphenyl ether, 4,4′-diaminodiphenyl ether, 4,4′-diaminodiphenylmethane, diethylene triamine, dipropylene triamine, triethylene tetramine, 3,3′-diamino-N-methyldipropylamine, and oligomers or polymers of ethylene diamine, a polyetheramine based on polypropylene glycol and/or polyethylene glycol (such as a Jeffamine® Series D, ED and EDR from Hunstmann) particularly preferably, the crosslinking agent is adipic acid dihydrazide.

The equivalent molar ratio between the reactive groups of the crosslinking agent (and in particular the hydrazide groups) and the carbonyl groups varies advantageously from 0.3 to 1, in particular from 0.5 to 1. The equivalent molar ratio can be calculated by dividing the molar amount of reactive groups of the crosslinking agent by the molar amount of carbonyl groups that react with the reactive groups of the crosslinking agent. The molar amounts can be determined from the amount of monomer functionalized with a carbonyl group used to prepare the resin of the invention and the amount of crosslinking agent introduced into the aqueous dispersion of the invention.

In the aqueous dispersion of the invention, the resin can be partially or totally neutralized. Totally or partially neutralized refers to the carboxyl groups of the resin. According to a particular variant, said aqueous dispersion is free of any surfactant or dispersing agent. This means that said resin is capable, by virtue of its specific composition and structure, of forming a stable dispersion without the need for any surfactant or dispersing agent.

The neutralization can be carried out with an organic base, which under the neutralization conditions selectively neutralizes the carboxyl groups of the resin without adversely affecting the other groups of said resin. The neutralizing agent is preferably an organic amine, more preferably a secondary amine or a tertiary amine, and even more preferably bearing at least one hydroxy group. Preferably, the neutralizing agent is an organic amine chosen from ethylamine, diethylamine, triethylamine, ethylenediamine, dimethylaminoethanol or triethanolamine, and more preferably a tertiary amine such as dimethylaminoethanol or triethanolamine.

The aqueous dispersion of the invention advantageously has a pH ranging from 7 to 9, and more advantageously from 7.5 to 8.5.

According to a preferred embodiment, the dispersion of the invention is partially neutralized with a degree of neutralization of at least 20%, and preferably of at least 50%, of the carboxyl groups of said resin.

In the dispersion of the invention, the polymer particles measure advantageously from 50 to 300 nm, more advantageously from 100 to 250 nm, and even more advantageously from 150 to 200 nm. The size measurement of the polymer particles is carried out by light diffraction according to the ISO 22412:2017 standard.

The dispersion of the invention can have a dry extract ranging from 30 to 60%, and preferably from 40 to 60%. This content can be measured according to the ISO 3251 method.

The Brookfield viscosity of the aqueous dispersion of the invention, measured at 25° C., preferentially ranges from 50 to 1500 mPa·s, more preferentially from 50 to 1000 mPa·s, and even more preferentially from 50 to 500 mPa·s. Such a viscosity allows easy formulation of the final one-component crosslinkable composition, without affecting its application conditions.

The dispersion of the invention is substantially free of polymer particles having a weight-average molecular mass Mw greater than 500,000 g/mol, preferably greater than 250,000 g/mol, more preferably greater than 100,000 g/mol. Within the meaning of the invention, the term “the dispersion is substantially free of Z particles” means that the dispersion according to the invention contains less than 1%, less than 0.5%, less than 0.25%, less than 0.1% or else 0%, by weight of Z particles relative to the weight of the dry extract of the dispersion.

A third subject of the present invention relates to a process for the preparation of an aqueous resin dispersion according to the invention, comprising the following steps:
i-preparation of an organic resin according to the invention by radical polymerization in an organic solvent medium, preferably in at least one organic diluent, and even more preferably in at least one polar organic diluent,
ii-partial or total neutralization of the carboxyl groups of the resin obtained in step i-, by addition of a neutralizing agent such as a organic amine, and preferably by addition of a tertiary amine, without affecting the other groups of said resin,
iii-preparation of an aqueous resin dispersion by addition of water to the partially or totally neutralized resin obtained in step ii-, until phase inversion, preferably at a temperature ranging from 50 to 80° C., and
iv-addition of a crosslinking agent, preferably functionalized with at least two —NH₂ or —NH groups, within the aqueous resin dispersion obtained in step iii-.

More particularly, step i- of preparing said resin comprises the preparation of said polymers P1 and P2 in two successive steps i1- and i2-in the same reactor:
i1—the preparation in solution of a first polymer P1 as defined according to the invention, and
i2—the preparation of a second polymer P2 as defined according to the invention, in the same reactor already containing said first polymer P1,
said polymers P1 and P2 being subsequently copolymerized with each other, preferably by radical polymerization.

The process of the invention may also comprise an additional step iv- of removal of the organic diluent, preferably by stripping (also termed “entrainment”) with steam or stripping with an inert gas.

The process of the invention may also comprise an additional step v- of adjustment of the final dilution of said aqueous dispersion relative to the target final solids content.

The present invention also relates to the use of a resin according to the invention or of an aqueous dispersion according to the invention, in a one-component crosslinkable composition, said composition preferably being free of melamine or isocyanate crosslinking agent.

A fifth subject of the invention also relates to a one-component crosslinkable composition comprising at least one aqueous dispersion according to the invention, said composition preferably being free of melamine or isocyanate crosslinking agent, in an organic solvent medium or in aqueous medium, and preferably in aqueous medium. Thus, the one-component crosslinkable composition of the invention is advantageously an aqueous coating composition.

The crosslinking agent reacts with the resin of the invention during the application of the one-component crosslinkable composition of the invention to evolve irreversibly over time toward a crosslinked coating forming a polymer network of infinite molecular mass and three-dimensional structure.

The one-component crosslinkable composition of the invention is advantageously free of catalyst based on metal derivatives.

According to a preferred embodiment of the invention, the one-component crosslinkable composition is a coating composition chosen from paint, varnish, ink, adhesive and glue compositions, and preferably an aqueous coating composition chosen from aqueous paint or varnish compositions. In particular, the one-component crosslinkable composition of the invention may be a protective coating composition, in particular a finishing coating composition or an anti-corrosion coating composition, or a decorative coating composition. These coating compositions are particularly suitable for applications in the following fields: railway construction and renovation, automotive, road transport, naval, aeronautics, agricultural machinery, public works machinery, wind turbines, oil platforms, containers, metal buildings, metal frames, coil or building including furniture, flooring, joinery and carpentry.

Another subject of the invention relates to a process for preparation of a coating, comprising a step of application of a one-component crosslinkable composition according to the invention to a substrate, followed by a step of drying of the crosslinkable composition, preferably at room temperature (20° C.). The process for preparation of a coating according to the invention does not include a prior step of mixing of the one-component crosslinkable composition with a separate crosslinking agent, in particular with a melamine or isocyanate crosslinking agent.

The one-component crosslinkable composition of the invention is preferably applied to a substrate chosen from metal, glass, wood, including chipboard and plywood, plastic, metal, concrete, plaster, composite and textile substrates.

Finally, the last subject of the invention relates to a substrate coated with a one-component crosslinkable composition according to the invention, preferably chosen from substrates made of metal, glass, wood, including chipboard and plywood, plastic, metal, concrete, plaster, composite and textile.

In addition to the foregoing provisions, the invention also comprises other provisions which will emerge from the additional description which follows, which relates to examples of synthesis of organic resin and of aqueous resin dispersion according to the invention, and to the evaluation of one-component crosslinkable compositions comprising them.

### EXAMPLES

Measurement Methods:

In the present patent application, the following measurement methods were used:

Measurement of the dry extract (solids content) of the organic resin: according to the ISO 3251:2019 standard (1 g of resin in solution for 1 hour at 125° C.).

Acid number of the organic resin: according to the ISO 2114:2000 standard (expressed in mg of KOH per g of dry resin).

Measurement of number-average molecular weights Mn: by GPC in THF with calibration based on monodispersed polystyrene standards, with Mn expressed in polystyrene equivalents, the measurement conditions being as follows: Columns based on crosslinked polystyrene-divinylbenzene (PS-DVB) gel (2 mixed columns D (ref. 1110-6504)+1 column 100 Å(ref 1110-6520)+1 column 50 Å(ref. 1110-6515), (7.8 mm×300 mm) marketed by Agilent,
Eluent: THF,
Mobile phase rate (THF): 1 mL/min,
T°: 35° C.,
IR detection
Calibration: PS standards (Mw: 465 600, 364 000, 217 000, 107 100, 45 120, 19 500, 9570, 4750, 3090, 1230, 580, 162 g/mol).

Measurement of the pH of the emulsion: measured according to the ISO 976:2013 standard.

Measurement of the viscosity of the emulsified organic resin: measured on a Brookfield DV-E viscometer, 25° C., 100 rpm, S03 (according to the ISO 2555 standard).

Average particle size and polydispersity index: measured by light diffraction according to the ISO 22412:2017 standard.

20°/60°/85° gloss:

The gloss is measured after application with a film applicator of a wet crosslinkable composition with a thickness of 200 μm (dry thickness: 50 μm) on a QD46 steel plate (in an air-conditioned room at 23° C. and 50% relative humidity) and drying for 24 hours. The measurements of gloss at 20°, 60° and 85° are carried out according to standard NF EN ISO 2813 (2014) (in an air-conditioned room at 23° C. and 50% relative humidity).

BK test: recording of drying time according to standard ISO 9117-4 (2012) The drying time is measured after application of a wet film of varnish of 150 μm, using a cubic applicator, to a glass substrate: 30×2.5×0.3 cm (in an air-conditioned room at 23° C. and 50% relative humidity). The drying time is recorded using a BK type device (Beck Koller) (Labomat Essor) with three scrolling speeds of a needle on the film of varnish. The needle is guided on a track formed during the application of the film. Several drying times are measured:
“BK1” drying time which corresponds to an imprint of the needle on the coating (corresponding to the evaporation time of the solvent),
“BK2” drying time which corresponds to the cutting of a continuous track on the coating (corresponding to a sol-gel transition),
“BK3” drying time which corresponds to the time required for the track traced by the needle on the coating to be interrupted (corresponding to the drying time at the surface).

Chemical Resistance:

The chemical resistance is evaluated after application with a film applicator of a varnish composition with a thickness of 50 μm (dry thickness) on an S46 steel plate (in an air-conditioned room at 23° C. and 50% relative humidity).

The chemical resistance is measured using a Taber® 5750 linear abrasion tester after drying of the film for a week in an air-conditioned room at 23° C. and 50% relative humidity. The methyl ethyl ketone (MEK) resistance of the varnish film is evaluated by the time required (in seconds) for the wear of the varnish surface with a one kilogram weight equipped with a cotton pad soaked in MEK performing back-and-forth movements on the coating to be tested, until the varnish is completely destroyed.

Persoz Hardness:

The Persoz hardness is measured after application with a film applicator of a varnish composition with a thickness of 50 μm (dry thickness) on a QD46 steel plate (in an air-conditioned room at 23° C. and 50% relative humidity). The Persoz hardness is measured on a pendulum for 7 days according to standard NF EN ISO 1522 of March 2007.

Water Resistance Test During Drying:

The water resistance test during drying simulates rain falling on a nondry film of varnish to assess its impact on the appearance of the coating, using a drop of water for placement on the varnish for a given time.

This test is carried out after application of a wet varnish composition with a thickness of 50 μm on a glass plate (in an air-conditioned room at 23° C. and 50% relative humidity) and a drying time of 10 minutes. A drop of water is applied with a pipette, allowed to dry for 30 minutes, then a further drop of water is applied after 3 hours, then again allowed to dry for 30 minutes, and the mark observed is rated as follows:
5=No visible change,
4=Very slight change (halo that forms an outline, then disappears)
3=Slight change in appearance, light haze, outline trace
2=Appearance of a modification of the structure of the coating (slight blisters, haze, bleaching, etc.)
1=Significant change in the structure of the coating (intense blistering, peeling, water in the film, etc.)
0=Destruction of the coating.

### Example 1: Preparation of an Aqueous Dispersion of Organic Resin According to the Invention

The composition of the organic resin of Example 1 is indicated in Table 1 below (the amounts are expressed in % by weight):

TABLE 1

| | Copolymer 1 | Copolymer 2 | Total organic resin |
|---|---|---|---|
| | % by weight P1 (relative | % by weight P2 (relative | % by weight (relative |
| | to the total weight of | to the total weight of | to the total weight of |
| Monomers | monomers) | monomers) | monomers) |
| Styrene | 23.7 | 3.9 | 27.6 |
| Methyl methacrylate | 14.6 | 3.3 | 17.9 |
| Butyl acrylate | 12.9 | 7.6 | 20.5 |
| Diacetone acrylamide | 21 | 7 | 28 |
| Lauryl methacrylate | 2.8 | 0.9 | 3.7 |
| Acrylic acid | 0 | 2.3 | 2.3 |

### Synthesis of the Acrylic Organic Resin

180 g of 2-butoxyethanol and 78 g of polypropylene glycol (Mn=1000) are introduced into a 2 L reactor. The reactor is then brought to 150° C. under nitrogen blanketing. In parallel, 355 g of styrene, 218 g of methyl methacrylate, 194 g of butyl acrylate, 316 g of diacetone acrylamide and 42 g of lauryl methacrylate are mixed in order to obtain a first polymer of composition P1. A solution of 34 g of di-tert-butyl peroxide and 17 g of tert-butyl peroctoate in 51 g of 2-butoxyethanol is also prepared. These two preparations are then introduced in parallel into the reactor, over a period of 3 hours, at 150° C.

At the end of these additions, the medium is cooled to 135° C.

At the same time, a mixture of 59 g of styrene, 49 g of methyl methacrylate, 114 g of butyl acrylate, 105 g of diacetone acrylamide, 13.5 g of lauryl methacrylate and 34.5 g of acrylic acid for the second polymer of composition P2, and also a solution of 11 g of di-tert-butyl peroxide and 6 g of tert-butyl peroctoate in 17 g of 2-butyoxyethanol, are prepared. These two preparations are introduced into the reactor at 135° C. over a period of 2 hours. At the end of these additions, the temperature is kept constant at 135° C. for an additional 1 hour.

Characteristics of the acrylic organic resin obtained:
Dry extract=85.0% dry extract,
Acid number of 16.5 mg KOH/g, and
Number-average molecular mass Mn (measured by GPC, with THF as solvent and with calibration by monodisperse polystyrenes)=2,850 g/mol.

### Preparation of the Aqueous Dispersion of Acrylic Organic Resin with Crosslinking Agent

529 g of the previously prepared resin are partially neutralized by adding 118 mL of a 6.5% by weight solution of dimethylethanolamine in water over a period of 10 minutes. During this step, the temperature goes from 90° C. to 70° C. and the stirring speed is 150 rpm (revolutions per minute). After 15 minutes of stirring at 70° C., 353 g of water are introduced over 45 minutes at a stirring speed of 250 rpm, with phase inversion during this addition. The emulsion obtained is then diluted with water to obtain the following characteristics:
Dry extract=46%,
pH=8.0,
Particle size=180 nm, and
Polydispersity index=0.03.
A crosslinking agent is then added to the previously prepared aqueous dispersion: 9.16 g of adipic acid dihydrazide (AADH) and 22 g of water are added to 150 g of the aqueous dispersion of acrylic organic resin previously prepared. The mixture is stirred vigorously using a DISPERMAT disperser® at a speed of 1 000 rpm when adding the crosslinking agent, then at 1 400 rpm for 30 minutes.

### Example 2: Preparation of a Comparative Aqueous Dispersion of Organic Resin

An organic resin is prepared according to the same protocol as that described in Example 1. An aqueous dispersion of organic resin is also prepared according to the same protocol as that described in Example 1, but without the step of adding the crosslinking agent AADH.

Example 3: Preparation and evaluation of crosslinkable coating compositions Two coating compositions 1 and 2 respectively comprising the aqueous dispersions of Example 1 and Example 2 are prepared. The formulations of these coating compositions are summarized in Table 2 below (the amounts are expressed in % by weight):

TABLE 2

| | Coating | Coating |
|---|---|---|
| | composition 1 | composition 2 |
| Raw materials | (weight in g) | (weight in g) |
| Aqueous dispersion of example 1 | 82.78 | — |
| (with AADH) | | |
| Aqueous dispersion of example 2 | — | 94.00 |
| (no AADH) | | |
| AADH | 5.06 | — |
| Demineralized water | 12.16 | 6.00 |
| TOTAL | 100 | 100 |

Procedure for the Preparation of Varnish Compositions:

An additional quantity of demineralized water is added respectively to the aqueous dispersion of Example 1 and to the aqueous dispersion of Example 2, to obtain two coating compositions (varnish) 1 and 2 each having a dry extract of 42.3%.

A comparative two-component coating composition 3 is also tested. For this, 75.16% by weight of a part A consisting of a Synaqua® E21011 resin dispersion (hydroxylated and carboxylated acrylic polymer dispersion) (ARKEMA) are mixed with 24.84% by weight of a part B consisting of Basonat® HW 1180 PC (polyisocyanate crosslinking agent) (BASF), to form a coating composition 3.

Performance characteristics of the crosslinked varnish coatings obtained: The results of the tests described above are summarized in Table 3 below:

TABLE 3

| | Coating | Coating | Coating |
|---|---|---|---|
| | composition 1 | composition 2 | composition 3 |
| Film appearance | Transparent and | Transparent and | Transparent and |
| | colorless | slightly white haze | colorless with many |
| | | | pinholes present |
| Gloss 20°/60°/85° | 146/162/117 | 160/166/116 | 158/176/116 |
| Drying (BK1/2/3) | 12 min/<30 min/<30 min | 14 min/6 h 40/>24 h | 19 min/52 min/1 h 35 |
| Chemical resistance | 45 | 5 | 70 |
| (in seconds) | | | |
| Persoz hardness (at 7 days) | 176 | 87 | 87 |
| Water resistance | 3 | 1 | 3 |

The crosslinked varnish obtained from the coating composition 1 has a good visual appearance with good film formation, compared to the coating composition 2, which does not lead to a transparent film, and to the two-component coating composition 3, which has many holes. The presence of a crosslinking agent within the aqueous resin dispersion allows crosslinking of the coating composition, without addition of separate crosslinking agent (ease of use), leading to a drying time and mechanical properties in terms of hardness and water resistance that are significantly improved, while maintaining good chemical resistance and high gloss power.

1. An organic resin comprising:
a polymer P1, and
a polymer P2 functionalized with carboxyl groups,
wherein said polymer P1 and/or said polymer P2 are functionalized with carbonyl groups, and
said resin has an acid number of between 10 and 50 mg KOH/g and a number-average molecular weight Mn of less than 25,000 g/mol.

2. The resin as claimed in claim 1, wherein the polymer P2 is more hydrophilic than the polymer P1.

3. The resin as claimed in claim 1 wherein the carbonyl group is carried by an ethylenically unsaturated monomer functionalized by a carbonyl group.

4. The resin as claimed in claim 1 wherein the polymer P1 is a copolymer comprising the following monomer units:
a1) at least one C₁-C₂ alkyl methacrylate monomer, and/or
a2) at least one C₄-C₈ alkyl acrylate monomer, and/or
a3) at least one C₁₀-C₁₄ alkyl (meth)acrylate monomer,
a4) optionally at least one aromatic vinyl monomer,
a5) at least one ethylenically unsaturated monomer functionalized by a carbonyl group, and
a6) optionally, at least one C₂-C₄ hydroxyalkyl (meth)acrylate monomer.

5. The resin as claimed in claim 1 wherein the polymer P2 is a copolymer comprising the following monomer units:
b1) at least one C₁-C₂ alkyl methacrylate monomer, and/or
b2) at least one C₄-C₈ alkyl acrylate monomer, and/or
b3) at least one C₁₀-C₁₄ alkyl (meth)acrylate monomer,
b4) optionally at least one aromatic vinyl monomer,
b5) at least one ethylenically unsaturated monomer functionalized by a carbonyl group, and
b6) at least one ethylenically unsaturated monomer functionalized with a carboxyl group, and
b7) optionally, at least one C₂-C₄ hydroxyalkyl (meth)acrylate monomer.

6. The resin as claimed in claim 1 wherein the polymers P1 and P2 are present in proportions by weight P1/P2 ranging from 90/10 to 60/40.

7. The resin as claimed in claim 1 wherein the polymer P1 and the polymer P2 have respective glass transition temperatures Tg1 and Tg2, measured by DSC (10° C./min 2 passages), as follows:
Tg1 ranging from 0 to 80° C., and
Tg2 ranging from 0 to 80° C.

8. An aqueous dispersion comprising at least one organic resin as claimed in claim 1 in a form dispersed in water and a crosslinking agent in water.

9. The aqueous dispersion as claimed in claim 8, wherein the crosslinking agent is selected from the group consisting of dihydrazide, such as adipic acid dihydrazide, oxalic acid dihydrazide, malonic acid dihydrazide, succinic acid dihydrazide, glutaric acid dihydrazide, pimelic acid dihydrazide, suberic acid dihydrazide, azelaic acid dihydrazide, sebacic acid dihydrazide, dodecanedioic acid dihydrazide, docosanedioic acid dihydrazide, isophthalic acid dihydrazide, maleic hydrazide and carbohydrazide; a polyhydrazide, polyacrylic polyhydrazide; hydrazine; a dihydrazone; an aliphatic, cycloaliphatic or aromatic polyamine, ethylene diamine, 1,2-diaminopropane, 1,3-diaminopropane, 1,2-diaminobutane, 1,3-diaminobutane, 1,4-diaminobutane, 1,5-penta methylenediamine, 1,6-hexamethylenediamine, 1,8-octamethylenediamine, 1,12-dodecamethylenediamine, 2,2-di methyl-1,3-propanediamine, 2-butyl-2-ethyl-1,5-pentanediamine, isophorone diamine, 1,2-, 1,3- or 1,4-diaminocyclohexane, 2-methylcyclohexane-1,3-diamine, 4-methylcyclohexane-1,3-diamine, 1,2-, 1,3- or 1,4-bis(aminomethyl)cyclohexane, diaminodecahydronaphthalene, 3,3′-dimethyl-4,4′-diaminodicyclohexylmethane, 4,4′-diaminodicyclohexylmethane, bis(aminomethyl)norbornane, piperazine, meta- and para-phenylenediamine, meta- and para-xylylenediamine, meta- and para-tolylenediamine, 3,4′-diaminodiphenylether, 4,4′-diaminodiphenylether, 4,4′-diaminodiphenylmethane, diethylenetriamine, dipropylenetriamine, triethylene tetramine, 3,3′-diamino-N-methyldipropylamine, and oligomers or polymers of ethylene diamine, a polyetheramine based on polypropylene glycol and/or polyethylene glycol, and adipic acid dihydrazide.

10. The aqueous dispersion as claimed in claim 8 wherein the resin is partially or totally neutralized by a neutralizing agent.

11. (canceled)

12. (canceled)

13. (canceled)

14. A one-component crosslinkable composition comprising at least one aqueous dispersion as claimed in claim 8.

15. The crosslinkable composition as claimed in claim 14, it which is an aqueous coating composition, a paint, a varnish, an ink, an adhesive or a glue composition.

16. A process for the preparation of a coating, comprising a step of application of the one-component crosslinkable composition as claimed in claim 14 on a substrate, followed by a step of drying of the crosslinkable composition.

17. The process as claimed in claim 16, not comprising a step of mixing of the one-component crosslinkable composition with a separate crosslinking agent.

18. A substrate coated with the one-component crosslinkable composition as claimed in claim 14 wherein the substrate is selected from the group consisting of metal, glass, wood, chipboard, plywood, plastic, metal, concrete, plaster, composite, and textile.
